(19) United States
(12) Patent Application Publication
(10) Pub. No.: US 2016/0332426 A1
(43) Pub. Date: Nov. 17, 2016

(54) THREE DIMENSIONAL PRINTING WITHIN POLYMERIC CURRENCY

(71) Applicant: International Business Machines Corporation, Armonk, NY (US)

(72) Inventors: Joseph Kuczynski, North Port, FL (US); Jason T. Wertz, Pleasant Valley, NY (US); Jing Zhang, Poughkeepsie, NY (US)

(21) Appl. No.: 14/709,566

(22) Filed: May 12, 2015

(51) Int. Cl. B32B 27/08; B32B 27/32; B32B 37/14; B42D 25/30

(52) U.S. Cl. CPC B32B 27/08; B42D 25/30; B32B 27/32; B32B 37/14; B32B 2255/10; B32B 2255/26; B32B 2307/518; B32B 2554/00; B33Y 80/00

(57) ABSTRACT

A method of manufacturing polymeric currency utilizing three dimensional objects may include forming a first and second layer of biaxially oriented polypropylene. Ink may be selectively applied to one or more portions of one or more sides of the first layer of biaxially oriented polypropylene. In response to applying the ink, one or more apertures may be created into the second layer of biaxially oriented polypropylene. The first and second layers of biaxially oriented polypropylene may be laminated together. A three dimensional object may be printed within the one or more apertures in the second layer of biaxially oriented polypropylene. In response to printing, a protective overcoat may be applied on top of the second layer of biaxially oriented polypropylene.

### BACKGROUND

The present disclosure relates generally to polymeric substrates, and more particularly, to anti-counterfeiting features for polymeric currency. Anti-counterfeiting features for currencies have been important in improving product verification and counterfeit deterrence. However, as counterfeiters become more sophisticated, it is important to continue to develop enhanced anti-counterfeiting features which provide additional levels of security for polymeric currencies.

### SUMMARY

Aspects of the disclosure include embodiments of a method of manufacturing polymeric currency utilizing three dimensional objects. In some embodiments, the method may include forming a first layer and a second layer of biaxially oriented polypropylene. Ink may be applied to one or more sides of the first layer of biaxially oriented polypropylene. The ink may be selectively applied to one or more portions of each of the one or more sides of the first layer. Into the second layer of biaxially oriented polypropylene, one or more apertures may be created. The second layer of biaxially oriented polypropylene may be laminated to the first layer of biaxially oriented polypropylene. Within the one or more apertures in the second layer of biaxially oriented polypropylene, a three dimensional object may be printed. In response to printing the three dimensional object, a protective overcoat may be applied on top of the second layer of biaxially oriented polypropylene.

In other embodiments, the method may include forming a first layer and a second layer of biaxially oriented polypropylene. Into the second layer of biaxially oriented polypropylene, one or more apertures may be created. The second layer of biaxially oriented polypropylene may be laminated to the first layer of biaxially oriented polypropylene. Within the one or more apertures in the second layer of biaxially oriented polypropylene, a three dimensional object may be printed. A third layer of biaxially oriented polypropylene may be laminated to the second layer of biaxially oriented polypropylene opposite the first layer of biaxially oriented polypropylene. Ink may be applied to one or more sides of the third layer of biaxially oriented polypropylene. The ink may be selectively applied to portions of the one or more sides of the third layer of biaxially oriented polypropylene. In response to applying ink, a protective overcoat may be applied to the third layer of biaxially oriented polypropylene.

Aspects of the present disclosure include a polymeric currency substrate. The polymeric currency substrate may include two or more biaxially oriented polypropylene layers. In embodiments, ink may be selectively applied to at least one biaxially oriented polypropylene layer on at least one side. A three dimensional printed object may be sealed between two of the biaxially oriented polypropylene layers. The three dimensional object may have a height less than or equal to the thickness of one of the two biaxially oriented polypropylene layers.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an exploded, isometric view of one embodiment of an example polymeric currency substrate utilizing three dimensional printing.

FIG. 2 depicts an exploded, isometric view of a second embodiment of an example polymeric currency substrate utilizing three dimensional printing.

FIG. 3A depicts a side view of one embodiment of an example polymeric currency substrate.

FIG. 3B depicts a top view of one embodiment of an example polymeric currency substrate.

FIG. 4 depicts one embodiment of an example process for manufacturing polymeric currency utilizing three dimensional printing.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate to manufacturing currency, and more particular aspects relate to improving the anti-counterfeit ability of polymeric substrates utilizing three dimensional printing. Counterfeit deterrence and the issues associated with authentication can be important for protecting both personal and government property. The usefulness of bills of currency, stock and bond certificates, credit cards, passports, bills of lading, as well as many other legal documents (e.g., wills, deeds, contracts, etc) are dependent upon how reliably authentic they are.

Anti-counterfeiting measures have been and will continue to be important to further improve product verification and counterfeit deterrence. These measures have been commonly used to protect not only the documents listed above, but also products within the markets of electronics, currency, art, pharmaceuticals, and logos. In the context of currency, anti-counterfeiting measures have become sophisticated. Some of the anti-counterfeiting measures within the realm of currency include the use of fluorescent dyes, which have typically been used to add a level of security that can be made visual under an ultraviolet light source. However, these fluorescent dyes can be reengineered and may only provide one level of security. Additionally, some anti-counterfeiting measures within the realm of currency have included the use of two-dimensional authentication mechanisms, such as watermarks.

Recently, in addition to the anti-counterfeiting measures discussed above, some countries (e.g., Australia, New Zealand, Canada, etc) have introduced polymer currency into circulation as an additional level of security. These banknotes are made from a polymer, such as biaxially oriented polypropylene (referred to herein as BOPP), and incorporate many security features not available to paper banknotes. For example, polymeric currency may be printed using metameric inks, meaning a printed pattern's appearance can change depending on the color of light shining on it. Due to the fact that a polymer bank note contains many security features that cannot be successfully reproduced by photocopying or scanning, it is very difficult to counterfeit. However, as counterfeiters get more creative, there may be a need to utilize new technologies in order to provide additional levels of security for currencies.

Embodiments of the present disclosure provide a method to improve anti-counterfeiting measures by incorporating nano-sized features (e.g., shapes) on and/or within polymeric substrates, such as polymeric currency, utilizing three dimensional (referred to herein as 3D) printing techniques. Nano-sized features are undetectable to the naked eye and may require expensive equipment in order to both produce and inspect polymeric currency containing the nano-sized features since standard optical microscopy cannot be used. Nano-sized features may include, for example, distinct unknown objects that are separate from any of the general patterning present on currency or may, for example, be printed directly on top of a previously created feature. These nano-sized printed features can be tailored to incorporate geometric shape changes that allow light to be reflected back or scattered in another direction similar to a shimmering effect. Additionally, using 3D printing techniques, these nano-sized features (e.g., shapes, figures, or images) could be loaded with additional dyes (e.g., Colored, Ultraviolet, or Infrared) and/or secondary media (e.g., magnetic particles, metal particles, or nanotubes) in order to generate different optical properties. The cost implications alone associated with the expensive equipment (e.g., high powered microscopes) may slow down or impede individuals from producing counterfeit polymeric currency containing printed 3D objects.

Aspects of the present disclosure include embodiments which exhibit some or all of these potential advantages. Additionally, some embodiments may include other advantages in lieu of or in addition to the potential advantages discussed above. Thus, while the present disclosure is not necessarily limited to such applications, various aspects of the disclosure may be appreciated through a discussion of various examples using this context.

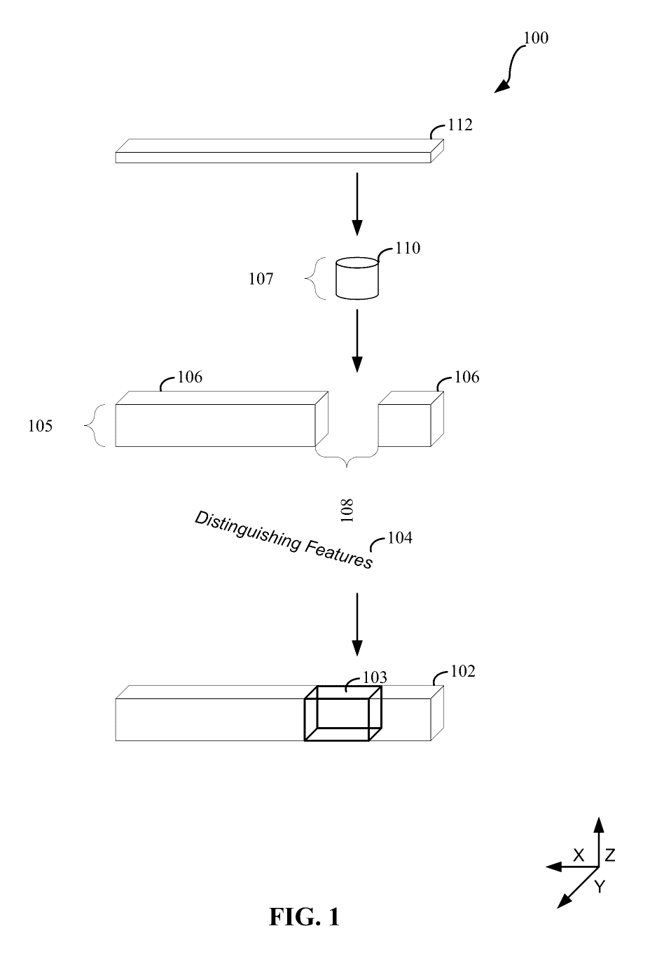

Referring to the drawings, where like numbers denote like parts throughout the several views, FIG. 1 depicts an exploded, isometric view of one embodiment of an example polymeric currency substrate utilizing 3D printing. This view depicts the various elements of the polymeric currency substrate 100 in an exploded position to better illustrate the individual components of the polymeric currency substrate 100. The polymeric currency substrate 100 comprises a first layer of BOPP 102, a set of distinguishing features 104, a second layer of BOPP 106, an aperture 108, a 3D object 110, and a protective overcoat layer 112. The arrows within FIG. 1 represent how the exploded individual components of the polymeric currency substrate 100 may fit together.

The first layer of BOPP 102 may be formed using techniques known to those skilled in the art. For example, BOPP film is produced when a polypropylene film is stretched in both machine and transverse directions directly following extrusion. In some embodiments, the first layer of BOPP 102 may be dimensioned to the size of a sheet that can be cut to multiple, smaller sheets (e.g., the size of a banknote). Alternatively, in other embodiments, the first layer of BOPP 102 may be dimensioned to the size of a banknote. Additionally, in some embodiments, the first layer of BOPP 102 may be transparent. Alternatively, the first layer of BOPP 102 may be made partially and/or entirely opaque by selectively applying ink to one or more sides of the first layer of BOPP 102 in other embodiments. The one or more sides may include, for example, the top and/or bottom sides of the first layer of BOPP 102, where the top and/or bottom sides are defined by a plane in the X and Y axes perpendicular to the Z axis. In certain embodiments, selectively applying ink to the one or more sides of the first layer of BOPP 102 may include leaving spaces within the one or more sides of the first layer of BOPP 102 to form one or more transparent windows 103.

In various embodiments, ink applied to the first layer of BOPP 102 may be used to incorporate a set of distinguishing features 104 within the opaque sections of the first layer of BOPP 102. For example, the set of distinguishing features 104 may include, but is not limited to, background images, portraits, and/or serial numbers. In certain embodiments, the set of distinguishing features 104 may be applied to the one or more transparent windows 103 within the first layer of BOPP 102 to create additional anti-counterfeiting measures. For example, the transparent window 103 and the thickness of the final polymeric currency substrate 100 product may be combined with images (e.g., a serial number) applied to the transparent window 103 to create moire effects that generate dynamic images (e.g., numerals that can move).

The second layer of BOPP 106 may be formed in a manner similar or the same as the first layer of BOPP 102. In embodiments, the dimensions of the second layer of BOPP 106 may be the same as dimensions for the first layer of BOPP 102. The height 105 (e.g., thickness) of the second layer of BOPP 106 is sufficient to allow the 3D object 110 to be recessed below the surface of the second layer of BOPP 106. In certain embodiments, the second layer of BOPP 106 may be transparent. In this embodiment, the second layer of BOPP 106 is cut to create an aperture 108 into the second layer of BOPP 106. In embodiments, creating an aperture includes using techniques known to those skilled in the art for removing portions of a substrate (e.g., etching, cutting, punching). Although only one aperture 108 is shown in the example of FIG. 1, it is understood that in other embodiments, the second layer of BOPP 106 may be cut to create more than one aperture 108 in the second layer of BOPP 106.

In various embodiments, the aperture 108 may vertically extend (e.g., along the Z axis) entirely through the portion of the second layer of BOPP 106, creating two components or segments of the second layer of BOPP 106, as shown in FIG. 1. In other embodiments, the aperture 108 may vertically extend (e.g., along the Z axis) through a portion of the second layer of BOPP 106, leaving the second layer of BOPP 106 intact as one component. In further embodiments, the aperture 108 may extend partially through the X and/or Y axes. In certain embodiments, the aperture 108 may be cut within the first layer of BOPP 102, where the aperture 108 extends partially (e.g., along the X, Y, and/or Z axis) through the first layer of BOPP 102. In particular, the aperture 108 may be cut within the first layer of BOPP 102 in addition to or in lieu of cutting the aperture 108 within the second layer of BOPP 106.

The size of the aperture 108 (e.g., length, width, and height) may depend upon the size of the 3D object 110. In some embodiments, the size of the aperture 108 may be at least two times greater than the length, width, and height of the 3D object 110. The first layer of BOPP 102 may be joined with the second layer of BOPP 106 to create a single substrate through a lamination process described herein. In embodiments, creating the aperture 108 may occur either before and/or after the first layer of BOPP 102 and second layer of BOPP 106 are laminated together. For example, an aperture 108 may be cut into the polymeric currency substrate 100, where the location of the aperture 108 is aligned with the transparent window 103 previously formed within the first layer of BOPP 102. This may allow the 3D object 110, once printed within the aperture 108, to utilize the properties associated with transparent windows 103 discussed previously (e.g., the appearance of moving images).

The 3D object 110 may be printed within the aperture 108 utilizing techniques known to those skilled in the art (e.g., Photonic Professional GT). In some embodiments, the height 107 of the 3D object 110 is less than or equal to the height 105 of the second layer of BOPP 106. In certain embodiments, the second layer of BOPP 106 may include at least one or more sublayers of BOPP. The 3D object 110 may include a polymeric matrix. In various embodiments, the polymeric matrix has a melting temperature above the melting temperature of the first layer of BOPP 102. For example, in some embodiments, the polymer matrix is Taulman 645 Nylon, which has a melting temperature of approximately 194° C. whereas BOPP has a melting temperature of approximately 130° C. In embodiments where the polymeric matrix has a melting temperature above the melting temperature of the layer of BOPP, printing the 3D object 110 within the aperture 108 may result in localized melting between the 3D object 110 and the BOPP layer it is printed into, thus bonding the 3D object to the BOPP layer.

In some embodiments, the polymeric matrix includes anti-counterfeiting features. In certain embodiments, anti-counterfeiting features may include materials (e.g., nano-3D printer dispensable resins) used to create additional levels of security within the 3D object 110 and/or polymeric currency. In various embodiments, the anti-counterfeiting features may include for example, but are not limited to, nano-features (e.g., nanometric Radio-frequency identification (RFID), photosensitive films), additive dyes (e.g., colored dyes, ultraviolet (UV) dyes, Infrared (IR) dyes, fluorescent dyes) and secondary media (e.g., magnetic particles, metal particles, nanotubes, nanocrystals). The polymeric matrix of the 3D object 110 may be printed at a temperature above the melting temperature of the substrate on which it is printed (e.g., for BOPP, it may be 200° C.).

In various embodiments, the 3D object 110 may include a plurality of individual layers utilizing a plurality of polymeric matrices. Each individual layer may include a distinct polymeric matrix. The individual layers including distinct polymeric matrices may be printed consecutively and/or may be printed in a pattern (e.g., Layer A, Layer B, Layer C, Layer B, Layer A). For example, when printing the 3D object 110 within the aperture 108, the first layer of the 3D object 110 may include a first polymeric matrix (e.g., including nano-features) while the second layer of the 3D object 110 may include a second polymeric matrix (e.g., including a combination of additive dyes and secondary media). Accordingly, the printed 3D object 110 may include a plurality of anti-counterfeiting features utilizing the optical properties of the materials within each layer. In various embodiments, the 3D object 110 may be printed using a polymer substrate, such as BOPP.

The 3D object 110 may be any shape, figure, or image that has physical length, width and depth. In embodiments, the 3D object 110 may be as small as a grain of sand or equivalent in size to the width of several human hairs (e.g., approximately 10 μm-100 μm). For example, the 3D object 110 may include intricately structured sculptures, for example, but not limited to, a government logo, a barcode, a race car, a portrait, or a pyramid. In certain embodiments, the polymeric currency substrate 100 may include more than one 3D objects 110. For example, a second 3D object may be printed next to and/or on top of a first 3D object (e.g., 3D object 110).

In some embodiments, the protective overcoat layer 112 may be transparent and may include multiple sublayers. In certain embodiments, the protective overcoat layer 112 may be a layer of BOPP. In further embodiments, the protective overcoat layer 112 may include a layer of varnish. The protective overcoat layer 112 may be laminated to the side of the second layer of BOPP 106 containing the aperture 108. Laminating the protective overcoat layer 112 to the second layer of BOPP 106 may include covering the aperture 108 after the 3D object 110 has been printed within the aperture 108.

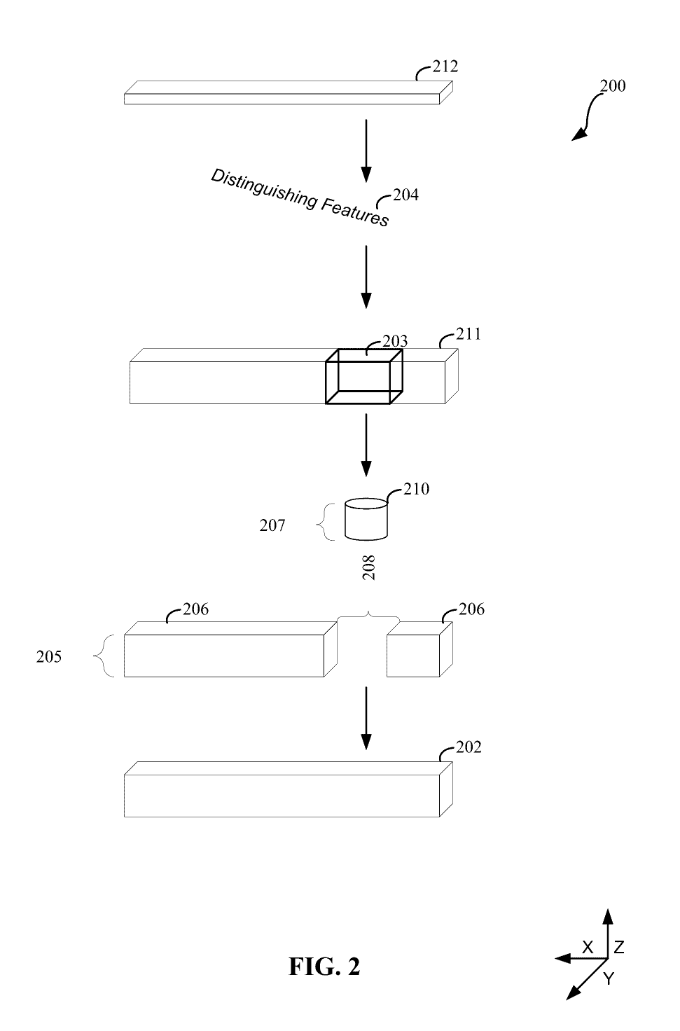

FIG. 2 depicts an exploded, isometric view of a second embodiment of a polymeric currency substrate utilizing three dimensional printing. This view depicts the various elements of the polymeric currency substrate 200 in an exploded position to better illustrate the individual components of the polymeric currency substrate 200. The polymeric currency substrate 200 comprises a first layer of BOPP 202, a set of distinguishing features 204, a second layer of BOPP 206, an aperture 208, a 3D object 210, a third layer of BOPP 211 and a protective overcoat layer 212. The arrows within FIG. 2 represent how the exploded individual components of the polymeric currency substrate 200 may fit together.

The first layer of BOPP 202 may be formed using techniques known to those skilled in the art. For example, BOPP film is produced when a polypropylene film is stretched in both machine and transverse directions directly following extrusion. In some embodiments, the first layer of BOPP 202 may be dimensioned to the size of a sheet that can be cut to multiple, smaller sheets (e.g., the size of a banknote). Alternatively, in other embodiments, the first layer of BOPP 202 may be dimensioned to the size of a banknote. Additionally, in some embodiments, the first layer of BOPP 202 may be transparent.

The second layer of BOPP 206 may be formed in a manner similar or the same as the first layer of BOPP 202. In embodiments, the dimensions of the second layer of BOPP 206 may be the same as dimensions for the first layer of BOPP 202. The height 205 (e.g., thickness) of the second layer of BOPP 206 is sufficient to allow the 3D object 210 to be recessed below the surface of the second layer of BOPP 206. In certain embodiments, the second layer of BOPP 206 may be transparent. In this embodiment, the second layer of BOPP 206 is cut to create an aperture 208 into the second layer of BOPP 206. Although only one aperture 208 is shown in the example FIG. 2, it is to be understood that in other embodiments, the second layer of BOPP 206 may be cut to create more than one aperture 208 in the second layer of BOPP 206.

In various embodiments, the aperture 208 may vertically extend (e.g., along the Z axis) entirely through the portion of the second layer of BOPP 206, creating two components or segments of the second layer of BOPP 206, as shown in FIG. 2. In other embodiments, the aperture 108 may vertically extend (e.g., along the Z axis) through a portion of the second layer of BOPP 206, leaving the second layer of BOPP intact as one component. In further embodiments, the aperture 208 may extend partially through the X and/or Y axes. In certain embodiments, the aperture 208 may be cut within the first layer of BOPP 202, where the aperture 208 extends partially (e.g., along the X, Y, and/or Z axis) through the first layer of BOPP 202. In particular, the aperture 208 may be cut within the first layer of BOPP 202 in addition to or in lieu of cutting the aperture 208 within the second layer of BOPP 206.

The size of the aperture 208 (e.g., length, width, and height) may depend upon the size of the 3D object 210. In some embodiments, the aperture 208 may be at least two times greater than the length, width, and height of the 3D object 210. The first layer of BOPP 202 may be joined with the second layer of BOPP 206 to create a single substrate through a lamination process described herein. In embodiments, creating the aperture 208 may occur either before and/or after the first layer of BOPP 202 and second layer of BOPP 206 are laminated together. For example, an aperture 208 may be cut into at least one layer of BOPP (e.g., the first layer of BOPP 202 and/or the second layer of BOPP 206), where the location of the aperture 208 is aligned with a transparent window 203 formed within the third layer of BOPP 211. This may allow the 3D object 210, once printed within the aperture 208, to utilize the properties associated with transparent windows discussed previously (e.g., the appearance of moving images).

The 3D object 210 may be printed within the aperture 208 utilizing printers and/or techniques known to those skilled in the art (e.g., Photonic Professional GT). In some embodiments, the height 207 of the 3D object 210 is less than or equal to the height 205 (e.g., thickness) of the second layer of BOPP 206. In certain embodiments, the second layer of BOPP 206 may include at least one or more sublayers of BOPP. The 3D object 210 may include a polymeric matrix. In various embodiments, the polymeric matrix has a melting temperature above the melting temperature of the first layer of BOPP 202. For example, in some embodiments, the polymer matrix is Taulman 645 Nylon, which has a melting temperature of approximately 194° C. whereas BOPP has a melting temperature of approximately 130° C. In embodiments where the polymeric matrix has a melting temperature above the melting temperature of the layer of BOPP, printing the 3D object 210 within the aperture 208 may result in localized melting between the 3D object 210 and the BOPP layer it is printed into, thus bonding the 3D object to the BOPP layer.

In some embodiments, the polymeric matrix includes anti-counterfeiting features. In certain embodiments, anti-counterfeiting features may include materials (e.g., nano-3D printer dispensable resins) used to create additional levels of security within the 3D object 210 and/or polymeric currency. In various embodiments, the anti-counterfeiting features may include for example, but are not limited to, nano-features (e.g., nanometric radio-frequency identification (RFID), photosensitive films), additive dyes (e.g., colored dyes, UV dyes, IR dyes, fluorescent dyes) and secondary media (e.g., magnetic particles, metal particles, nanotubes). The polymeric matrix of the 3D object 210 may be printed at a temperature above the melting temperature of the substrate on which it is printed (e.g., for BOPP, it may be 200° C.).

In various embodiments, the 3D object 210 may include a plurality of individual layers utilizing a plurality of polymeric matrices. Each individual layer may include a distinct polymeric matrix. The individual layers including distinct polymeric matrices may be printed consecutively and/or may be printed in a pattern (e.g., Layer A, Layer B, Layer C, Layer B, Layer A). For example, when printing the 3D object 210 within the aperture 208, the first layer of the 3D object 210 may include a first polymeric matrix (e.g., including nano-features) while the second layer of the 3D object 210 may include a second polymeric matrix (e.g., including a combination of additive dyes and secondary media). Accordingly, the printed 3D object 210 may include a plurality of anti-counterfeiting features utilizing the optical properties of the materials within each layer.

The 3D object 210 may be any shape, figure, or image that has physical length, width and depth. In embodiments, the 3D object 210 may be as small as a grain of sand or equivalent in size to the width of several human hairs (e.g., approximately 10 μm-100 μm). For example, the 3D object 210 may include, for example, but is not limited to, a government logo, a barcode, a race car, a portrait, or a pyramid. In certain embodiments, the polymeric substrate 200 may include more than one 3D objects 210. For example, a second 3D object may be printed next to and/or on top of a first 3D object (e.g., 3D object 210).

The third layer of BOPP 211 may be formed in a manner similar to or the same as the first and second layers of BOPP 202 and 206, respectively. In some embodiments, the dimensions of the third layer of BOPP 211 may be the same as dimensions for the first layer of BOPP 202 and/or the second layer of BOPP 206. In certain embodiments, the third layer of BOPP 211 may be transparent. The third layer of BOPP 211 may be laminated to the second layer of BOPP 206 after the second layer of BOPP 206 has been laminated to the first layer of BOPP 202 and after the 3D object 210 has been printed within the one or more apertures 208. The third layer of BOPP 211 may be laminated to a side of the second layer of BOPP 206 such that it covers the aperture 208.

The third layer of BOPP 211 may be made partially and/or entirely opaque by selectively applying ink to one or more sides of the third layer of BOPP 211. The one or more sides may include, for example, the top and/or bottom sides of the third layer of BOPP 211, where the top and/or bottom sides are defined by a plane in the X and Y axes perpendicular to the Z axis. In certain embodiments, selectively applying ink to the one or more sides of the third layer of BOPP 211 may include leaving spaces within the one or more sides of the third layer of BOPP 211 to form one or more transparent windows 203. The ink may be applied to the third layer of BOPP 211 before and/or after the third layer of BOPP 211 is laminated to the second layer of BOPP 206.

In various embodiments, ink applied to the third layer of BOPP 211 may be used to incorporate a set of distinguishing features 204 within the opaque sections of the third layer of BOPP 211. The set of distinguishing features 204 may be applied to the third layer of BOPP 211 before and/or after the third layer of BOPP 211 is laminated to the second layer of BOPP 206. For example, the set of distinguishing features 204 may include, but is not limited to, background images, portraits, and/or serial numbers. In certain embodiments, the set of distinguishing features 204 may be applied to the one or more transparent windows 203 within the third layer of BOPP 211 to create additional anti-counterfeiting measures. For example, the transparent window 203 and the thickness of the final polymeric currency substrate 200 product may be combined with images (e.g., a serial number) applied to the transparent window 203 to create moire effects that generate dynamic images (e.g., numerals that can move).

In some embodiments, the protective overcoat layer 212 may be transparent and may include multiple sublayers. In certain embodiments, the protective overcoat layer 212 may be a layer of BOPP. In further embodiments, the protective overcoat layer 212 may include a layer of varnish. The protective overcoat layer 212 may be laminated to the side of the third layer of BOPP 211 opposite of the side of the third layer of BOPP 211 covering the aperture 208.

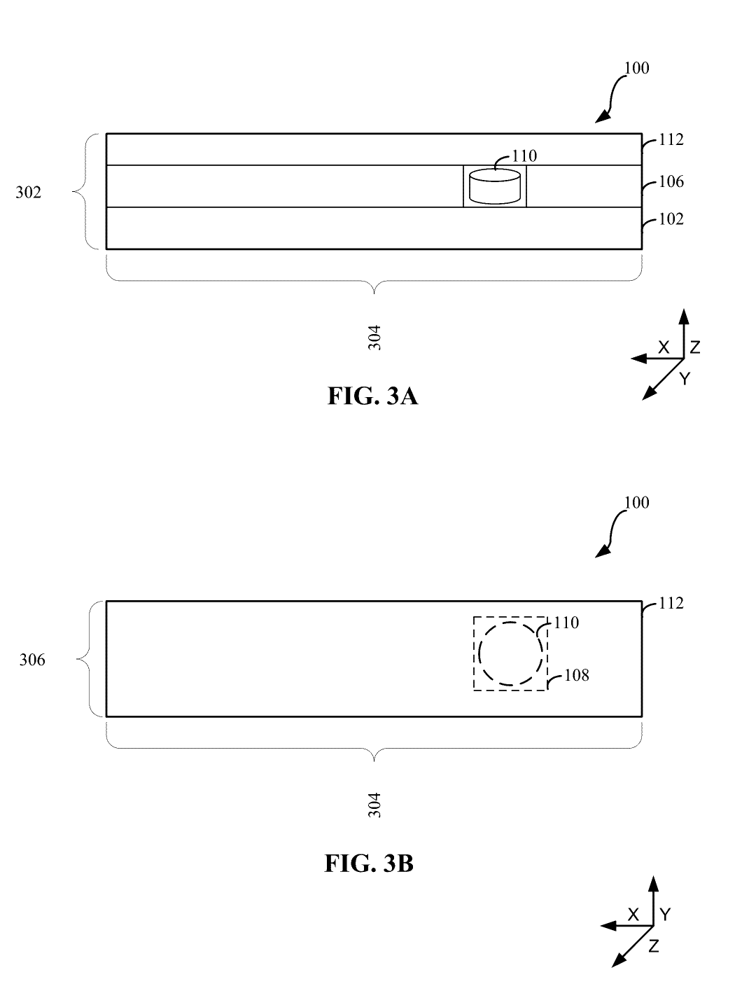

FIG. 3A depicts a side view of one embodiment of the example polymeric currency substrate 100 shown in FIG. 1. The polymeric currency substrate 100 includes a height 302, a length 304, a first layer of BOPP 102, a second layer of BOPP 106, an aperture 108, a 3D object 110, and a protective overcoat layer 112.

In embodiments, the first layer of BOPP 102, the second layer of BOPP 106, and the protective overcoat layer 112 may all include multiple, sublayers of BOPP. The second layer of BOPP 106 is sealed to the top and/or bottom of the first layer of BOPP 102 through a lamination process. In embodiments, the first layer of BOPP 102 and/or the second layer of BOPP 106 may include a set of distinguishing features, not pictured in FIG. 3A. Aspects of the present disclosure may be similar or the same as aspects described in FIG. 1 with respect to the set of distinguishing features 104. In some embodiments, the height 302 of the polymeric currency substrate 100 is between 125 μm to 140 μm and the length 304 of the polymeric currency substrate 100 is between 130 mm to 160 mm. It is to be understood that the ranges given for the sizes of the polymeric substrate 100 are for example only and are not intended to be limiting.

The aperture 108 may be cut into the second layer of BOPP 106 before and/or after the second layer of BOPP 106 has been sealed to the first layer of BOPP 102. In embodiments, the aperture 108 may be cut into the first layer of BOPP 102, not shown in FIG. 3A. The aperture 108 may extend partially and/or entirely through the BOPP layer into which it is created, according to embodiments. The 3D object 110 may be printed within the aperture 108 after the second layer of BOPP 106 is sealed to the first layer of BOPP 102. In embodiments, the 3D object 110 may be printed outside of the aperture 108 on the first layer of BOPP 102 and/or the second layer of BOPP 106. For example, a 3D logo may be printed directly onto a layer of BOPP. The protective overcoat layer 112 may be sealed to the second layer of BOPP 106 through a lamination process. The protective overcoat layer 112 may cover the side of the aperture 108 where the 3D object 110 was printed into and/or the side of the layer where the 3D object 110 was printed onto.

FIG. 3B depicts a top view of one embodiment of the example polymeric currency substrate 100 shown in FIG. 1. In various embodiments, the view of FIG. 3B may be construed to be an example bottom view of a polymeric currency substrate 100. The polymeric currency substrate 100 includes a length 304, a width 306, an aperture 108, a 3D object 110, and a protective overcoat layer 112. In some embodiments, the length 304 is between 130 mm to 160 mm and the width 306 is between 60 mm to 70 mm. However, it is to be understood that the above ranges are provided by way of example only and are not to be taken in a limiting sense.

Beneath the protective overcoat layer 112, the aperture 108 contains the printed 3D object 110. In embodiments, the protective overcoat layer 112 may be transparent such that a set of distinguishing features may be visible, although these features are not shown in FIG. 3B. Aspects of the present disclosure may be similar or the same as aspects described in FIG. 1 with respect to the set of distinguishing features 104.

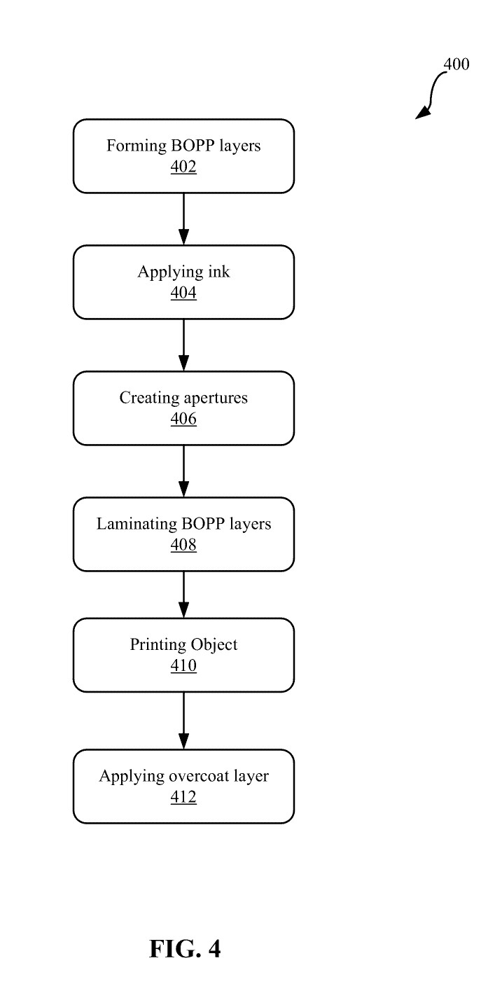

FIG. 4 depicts one embodiment of an example process 400 for manufacturing polymeric currency utilizing 3D printing. The process includes forming BOPP layers at block 402, applying ink at block 404, creating apertures at block 406, laminating BOPP layers at block 408, printing an object at block 410, and applying an overcoat layer at block 412. It is to be understood that the order in which the blocks listed above are discussed is not to be construed as limiting the order in which the individual acts may be performed. In particular, the acts performed may be performed simultaneously or in a different order than that discussed.

At block 402, at least a first layer and a second layer of BOPP may be formed using techniques known to those skilled in the art. In some embodiments, the layers of BOPP may be dimensioned to the size of a sheet that may me cut into multiple, smaller sheets (e.g., to the size of a banknote). Additionally, the plurality of layers of BOPP produced at block 402 are utilized later in the example process 400.

At block 404, ink may be applied to at least one of the plurality of layers of BOPP. The ink may be selectively applied such that portions of the at least one layer of BOPP may be opaque and other portions of the at least one layer of BOPP may be transparent. In various embodiments, ink may be applied to each layer of BOPP used in the example process 400 utilizing inks known to those skilled in the art. Applying the ink to at least one layer of BOPP may include incorporating a set of distinguishing features to the one or more sides of the at least one layer of BOPP. The distinguishing features may include, but are not limited to, background illustrations, portraits, serial numbers, and other images commonly used within currency substrates.

At block 406, at least one aperture may be created using a laser or a punch into at least one layer of BOPP. In some embodiments, the at least one aperture can be cut into the same layer or layers on which the ink was selectively applied at block 404. In other embodiments, at least one aperture can be cut into a different layer of plurality of layers of BOPP in addition to or in lieu of creating at least one aperture in the same layer or layers on which the ink was selectively applied at block 404. In some embodiments, an aperture is a cavity or hole into which a 3D object is printed into. Additionally, in some embodiments, the aperture is at least two times greater than the length, width, and height of the 3D object printed into it. In certain embodiments, the aperture may be cut into a first layer of BOPP, into a second layer of BOPP, and/or into a third layer of BOPP. For example, an aperture may be cut in a first location within the first layer of BOPP and a second aperture may be cut in a second location within the second layer of BOPP. In some embodiments, each aperture may extend at least partially in each direction (e.g. X axis, Y axis, and/or Z axis) through the respective layer into which it is cut. In addition, in some embodiments, each aperture may extend entirely through the respective layer into which it is cut in one or two of the directions (e.g. X axis, Y axis, and/or Z axis).

At block 408, the BOPP layers formed at block 402 are laminated together utilizing a laminating process. For instance, using the example discussed above, in some embodiments, a first layer of BOPP containing an aperture cut into the first layer of BOPP may be sealed together with a second layer of BOPP containing an aperture cut into the second layer of BOPP. Continuing the previous example, the aperture within the first layer of BOPP and the aperture within the second layer of BOPP may face each other (e.g., along the Z axis) such that the apertures, when aligned, form a single cavity. Conversely, the aperture within the first layer of BOPP and the aperture within the second layer of BOPP may not face each other (e.g., along the Z axis) such that, once laminated together, the two layers each contain an aperture. In some embodiments, the at least one aperture may be created before the layers of BOPP are sealed together. In certain embodiments, the at least one aperture may be created after the layers of BOPP are sealed together. In further embodiments, some apertures may be created before as well as after the layers of BOPP are sealed together. Finally, in various embodiments, the at least one aperture may be created after some of the layers of BOPP are sealed together but before all layers of BOPP for the process 400 have been sealed together. In various embodiments, the laminating process may include utilizing a laminating film machine to seal layers of BOPP together.

The laminating machine may operate as a dry and/or wet laminating film machine. In certain embodiments, the laminating process includes a laminating temperature, a laminating roller pressure, and a laminating speed. The laminating temperature range includes the temperature degrees by which the laminating process occurs. For example, the laminating temperature range for a dry laminating machine may be between 85 and 100° C. whereas the laminating temperature range for a wet laminating machine may be between 95 and 105° C., in some embodiments. The laminating roller pressure includes the amount of force applied to the layers of BOPP. For example, the laminating roller pressure for a dry laminating machine may be between 8 and 15 megapascals whereas the laminating roller pressure for a wet laminating machine may be between 10 and 20 megapascals, in some embodiments. The laminating speed is the speed by which the laminating pressure is applied to the layers of BOPP. For example, the laminating speed for both a dry and wet laminating machine may be between 8 and 50 meters per minute, in some embodiments.

At block 410, a 3D object is printed into the one or more apertures cut into the one or more layers of BOPP. Aspects of the present disclosure may be similar or the same as aspects described in FIG. 1 with respect to the 3D object 110. In some embodiments, a 3D object may be printed into the aperture before the layers of BOPP have been sealed together. In embodiments, a 3D object may be printed into the aperture after the layers of BOPP have been sealed together. In yet additional embodiments, one or more 3D objects may be printed into the aperture before the layers of BOPP have been sealed together and one or more 3D objects may be printed into the aperture after the layers of BOPP have been sealed together. For example, in an embodiment where an aperture is cut into a first layer of BOPP and a second layer of BOPP, a 3D object may be printed into the aperture within the first layer of BOPP, the first and second layers of BOPP may be sealed together, and then the 3D object may be printed into the aperture within the second layer of BOPP.

At block 412, an overcoat layer may be applied to the substrate including the plurality of BOPP layers containing the 3D object printed within an aperture. In some embodiments, the protective overcoat layer is a layer of BOPP. In certain embodiments, the protective overcoat layer includes a varnish. In various embodiments, when the protective overcoat includes a plurality of sublayers, the sublayers comprising BOPP or varnish, the varnish sublayers may be applied after all other layers have been applied. Applying the overcoat layer may include utilizing a laminating machine.

The laminating machine may operate as a dry and/or wet laminating film machine. In certain embodiments, applying the protective overcoat layer includes operating the laminating machine at an overcoat temperature, an overcoat roller pressure, and an overcoat application speed. The overcoat temperature includes the temperature degrees by which the laminating machine operates. For example, the overcoat temperature for a dry laminating machine may be between 85 and 100° C. whereas the overcoat temperature for a wet laminating machine may be between 95 and 105° C., in some embodiments. The overcoat roller pressure includes the amount of force applied to the layers of BOPP. For example, the overcoat roller pressure for a dry laminating machine may be between 8 and 15 megapascals whereas the overcoat roller pressure for a wet laminating machine may be between 10 and 20 megapascals, in some embodiments. The overcoat application speed is the speed by which the overcoat pressure is applied to the layers of BOPP. For example, the overcoat application speed for both a dry and wet laminating machine may be between 8 and 50 meters per minute, in some embodiments. In embodiments where the overcoat layer is a sublayer of varnish, the varnish layer is applied at room temperature (e.g., 16 to 20° C.), standard ambient pressure, and at similar speeds to the laminating speed and the overcoat application speed.

In embodiments, each block within the process 400 for manufacturing polymeric currency utilizing three dimensional printing may be performed entirely utilizing three dimensional printing technologies.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1-11. (canceled)

12. A polymeric currency substrate, comprising:
two or more biaxially oriented polypropylene layers, wherein ink is selectively applied to at least one biaxially oriented polypropylene layer on at least one side; and
a three dimensional printed object sealed between two of the biaxially oriented polypropylene layers, wherein the three dimensional printed object has a height less than or equal to the thickness of one of the two biaxially oriented polypropylene layers.

13. The polymeric currency substrate of claim 12, wherein the three dimensional printed object comprises a polymeric matrix, wherein the matrix includes anti-counterfeiting features.

14-20. (canceled)
